(19) United States
(12) Patent Application Publication
(10) Pub. No.: US 2008/0183447 A1
(43) Pub. Date: Jul. 31, 2008

(54) Automatic Input Function Estimation For Pharmacokinetic Modeling

(75) Inventors: Alexander Fischer, Aachen (DE); Timo Paulus, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,829

(22) PCT Filed: Jul. 11, 2006
(86) PCT No.: PCT/IB2006/052345

§ 371 Date: Jan. 16, 2008

Related U.S. Application Data
(60) Provisional application No. 60/701,338, filed on Jul. 21, 2005.

(51) Int. Cl. G06N 3/00; G06F 17/10; G06G 7/58

(52) U.S. Cl. 703/2; 703/11

(57) ABSTRACT

This system (200), apparatus (300), and method (100) of the present invention provide an analytic way to solve the (input) estimation problem of pharmacokinetic modeling: estimating parameters of a kinetic model from a series of tracer (radioactively labeled imaging agent) activity measurements (e.g. by positron emission tomography). Since the model describes a biological process its parameters have a direct functional interpretation (e.g. hypoxia for the tracer FMISO) that can be of diagnostic value. The measurements represent the activity distribution in time and space in the form of a 4D data set d(t, x, y, z), t=1, . . . , T. The kinetic parameter estimation procedure (205) requires knowledge of the tracer input activity. This input activity can either be measured invasively or it can be estimated from the data in a preprocessing step. The estimation problem can be solved efficiently if the model and its input are described analytically. Typically parameterized functions (often sums of exponential terms) (204) are fitted to the averaged data over a region of interest (ROI) (e.g. an artery or the left ventricular blood pool) in order to obtain an analytical input representation. The input function representation (functional form) (204) and its initial parameter values (205) have to be selected/specified prior to the fitting procedure 206). The present invention thereby reduces the amount of manual interaction and operator dependence in the evaluation of dynamic procedures.

The present invention is directed to providing a system, apparatus and method for automatic input function estimation for pharmacokinetic modeling that streamlines the workflow and reduces the amount of manual interaction and provides a dynamic procedure with kinetic modeling.

In order to avoid invasive arterial blood sampling non-invasive input estimation is a serious topic of interest and various approaches have been studied.

Reference tissue models rely on the presence of a reference tissue without specific binding of the ligand. In the reference tissue model, the time course of radio ligand uptake in the tissue of interest is expressed in terms of its uptake in the reference tissue, assuming that the level of nonspecific binding is the same in both tissues. They are commonly used in neurological applications. However they rely on the nonspecific binding assumption and were reported to have some loss in accuracy and increased bias and do not work well for all radiotracers.

A Population Mean approach aims at estimating in a first step the mean parameter values of the whole population as well as their probability distribution. This is then used in a second step to define a prior distribution for Bayesian estimation of individual parameters. It is applicable not only for input function estimation, but for model parameter estimation, too. It ha been applied to a tracer with complex metabolism including blood compartments where the blood input function is one compartment activity.

Blind identification circumvents explicit knowledge of the blood input completely. However at least three regions with identical input and different kinetic behavior have to be defined in order to solve the blind estimation problem and the input function is represented implicitly, only.

The system, apparatus and method of the present invention provide an effective and efficient automatic way to estimate an input function from a collection of functional representations. These representations may differ in form and number of terms. A typical functional representation is a sum of weighted exponentials.

$${c}_{p} ( t ) = {\sum }_{i = 1}^{N} {{A}_{i} ( \frac{t}{τ} )}^{{B}_{i}} {e}^{- {C}_{i} t / τ} \qquad ( 1 )$$

where N is the number of terms and t is time in s. The 3N+1 parameters are τ, Aᵢ, Bᵢ, Cᵢ, i=1, . . . , N. τ is a time normalization parameter (in most cases it will be used as a constant). The Aᵢ are activity weights, Bᵢ are dimensionless exponents and Cᵢ are normalized dimensionless time constants. Some parameters may be predefined. For example, small integer values of Bᵢ are favorable with regard to computational efficiency.

A preferred embodiment of the method of the automatic estimation procedure of the present invention is as follows

1. Creation/definition of a collection C={c_{p,1}(t), c_{p,2}(t), . . . , c_{p,M}(t)} of M input functions differing in functional form or number of predefined and free parameters. M can be chosen to cover all desired combinations of predefined parameter values and number of terms N.

2. Estimation of the (free) parameters of all input functions from the collection on the ROI averaged data

$$y ( t ) = \frac{1}{{N}_{ROI}} {\sum }_{( x , y , z ) ∈ ROI} d ( t , x , y , z ) \qquad ( 2 )$$

where N_{ROI} is the number of voxels in the ROI. The measurements represent the activity distribution in time (t) and space (x, y, z) in the form of a 4D data set d(t, x, y, z), t=1, . . . , T. The parameter estimation can be carried out with any nonlinear optimization procedure (e.g. Levenberg-Marquardt) solving

$${min}_{{A}_{i , j} , {B}_{i , j} , {C}_{i , j}} {χ}_{j}^{2} , {χ}_{j}^{2} = {\sum }_{t = 1}^{T} ρ ( t ) {( {c}_{p , j} ( t ) - y ( t ) )}^{2} , j = 1 , … , M \qquad ( 3 )$$

separately for all input functions c_{p,j}(t) from the collection. ρ(t) is a weighting function that allows more emphasis to be placed on some parts of the data (e.g. confidence information on the measured data). Initial parameter values usually play an important role in nonlinear optimization and have to be tackled first. For the input function class shown above a preferred way to obtain reasonable initial values is shown in the realization example below.

3. Computation of an “optimal” input function from all estimated input functions making use of goodness-of-fit criterion.

c_{p,opt}(t)=F(C) (4)

The goodness-of-fit (GOF) criterion assesses the fitting error χ² with regard to the modeling effort (number of parameters nₚ)

$$G O F = f ( {χ}^{2} , {n}_{p} ) , {χ}^{2} = {\sum }_{t = 1}^{T} {( {c}_{p} ( t ) - y ( t ) )}^{2} \qquad ( 5 )$$

Examples for goodness-of-fit criteria are Akaike's Information Criterion (AIC), ibid, or the Bayesian Information Criterion (BIC), see, e.g., Schwarz, G. Estimating the Dimension of a Model, The Annals of Statistics, Vol. 6, No. 2, 461-464, 1978. The optimal input function may be computed as a weighted sum

$${c}_{p , opt} ( t ) = {\sum }_{j = 1}^{M} {w}_{j} {c}_{p , j} ( t )$$

with the weights wⱼ being determined by the GOF criterion. Selection of the best fitting input function is preferably realized by the weights

$${w}_{j} = \{ \begin{matrix}1 & G O F ( {c}_{p , j} ) = {min}_{j} G O F ( {c}_{p , j} ) \\ 0 & otherwise\end{matrix} \qquad ( 6 )$$

The system, apparatus, and method of the present invention provide efficient fitting of analytical input functions with the advantages:
the need for manual interaction in the initial value definition (and the often necessary tuning) is reduced;
a whole collection of input functions of different type and number of parameters can be fitted in parallel and an “optimal” one can be selected further processing reducing the need for a hard choice of a specific functional representation based on intuition and/or expert knowledge;
the efficient formalism for kinetic parameter estimation based on a full analytical problem formulation can be used; and
the input function is still represented in an explicit fashion that can be used for procedure checks and result backtracking (if desired).

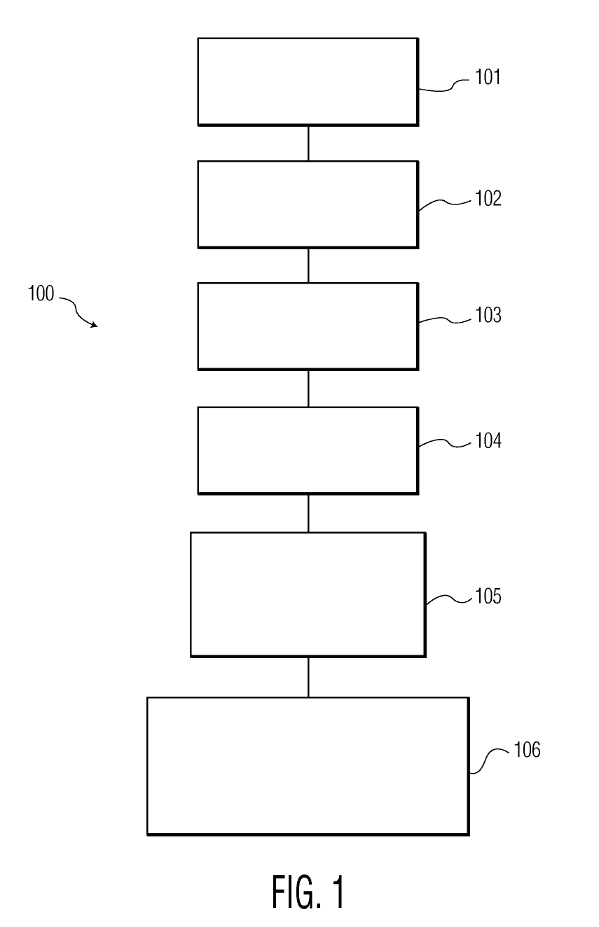

FIG. 1 illustrates a flow chart of a preferred embodiment of the present invention;

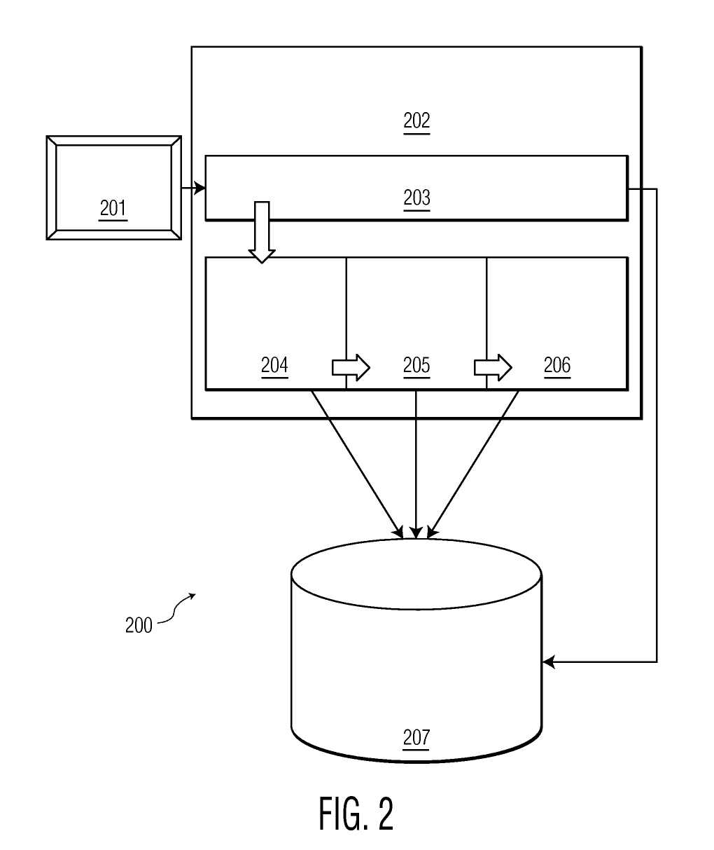

FIG. 2 illustrates an analysis apparatus modified according to the current invention;

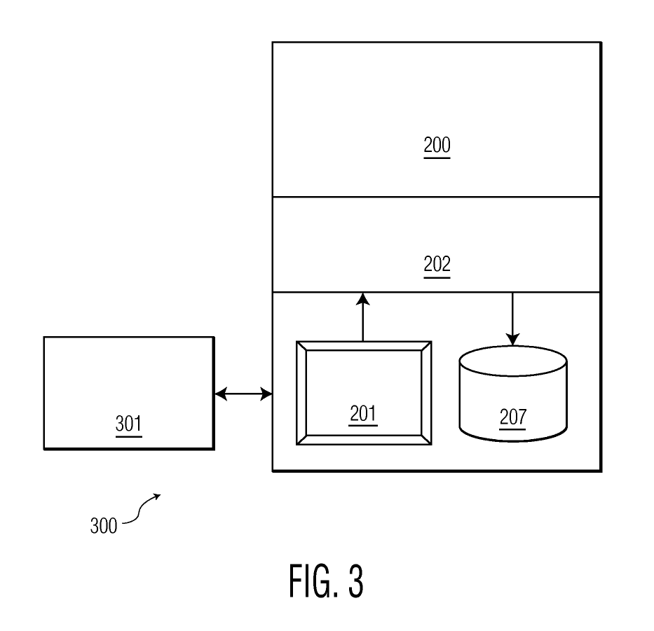

FIG. 3 illustrates an analysis system incorporating the analysis apparatus of FIG. 2.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

A preferred embodiment of the invention provides efficient fitting of analytical input functions with the following advantages:
the need for manual interaction in the initial value definition (and the often necessary tuning) is reduced;
a whole collection of input functions of different type and number of parameters can be fitted in parallel and an “optimal” one can be selected for further processing, thereby reducing the need for a hard choice of a specific functional representation based on intuition and/or expert knowledge;
the efficient formalism for kinetic parameter estimation based on a full analytical problem formulation can be used; and
the input function is still represented in an explicit fashion that can be used for procedure checks and result backtracking (if desired).

For an input function consisting of polynomial weighted exponentials, a preferred embodiment of an automatic estimation procedure 100 is illustrated in FIG. 1 and comprises the following steps:

1. Collection Definition

Define the exponents Bᵢ as constants (reasonable values are small cardinal numbers, such as 0, 1, 2, 3) at step 101 and vary them over the entries of the collection. This reduces the number of free parameters, maintains the computational advantage given by the chosen values, and makes the computation of initial parameter values more tractable.

At step 102 a collection of polynomial weighted exponential input functions is defined, for example, the functions

$$\begin{matrix}{c}_{p , 1} ( t ) = {A}_{1} ( \frac{t}{τ} ) {e}^{- {C}_{1} t / τ} & ( 7 ) \\ {c}_{p , 2} ( t ) = {A}_{1} {e}^{- {C}_{1} t / τ} & ( 8 ) \\ {c}_{p , 3} ( t ) = {A}_{1} ( \frac{t}{τ} ) {e}^{- {C}_{1} t / τ} + {A}_{2} ( \frac{t}{τ} ) {e}^{- {C}_{2} t / τ} & ( 9 ) \\ {c}_{p , 4} ( t ) = {{A}_{1} ( \frac{t}{τ} )}^{2} {e}^{- {C}_{1} t / τ} + {A}_{2} ( \frac{t}{τ} ) {e}^{- {C}_{2} t / τ} & ( 10 ) \\ {c}_{p , 5} ( t ) = {{A}_{1} ( \frac{t}{τ} )}^{2} {e}^{- {C}_{1} t / τ} + {{A}_{2} ( \frac{t}{τ} )}^{2} {e}^{- {C}_{2} t / τ} & ( 11 ) \\ {c}_{p , 6} ( t ) = … & ( 12 )\end{matrix}$$

2. (Free) Parameter Estimation

In order to start the parameter estimation, initial values for the parameters have to be determined. As these strongly influence the final result of a nonlinear fit, these parameters have to be chosen carefully. Obtain these initial values from the measured data as follows. Assume that the input function has a peak that should be modeled by the first term of the functional form. That is, determine a region of interest (ROI) and a peak therein at step 103. The further terms then describe the remaining parts (the tail). From the ROI averaged data, a set of reference points is extracted based on the peak location (eqs. (13)-(14)) that will be used for the initial parameter computation at step 104 as follows:

let

τ=a time normalization parameter (in most cases it is a constant)

T=number of time samples

N=number of terms in the input function

then the first point is the maximum or peak obtained using eqs. (13)-(14)

t_{max,1}=arg max y(t) (13)

y_{max,1}=y(t_{max,1}) (14)

t_{max,j}=t_{max,j-1}+(T−t_{max,1})/N, j=2, . . . , N (15)

y_{max,j}=y(t_{max,j}), j=2, . . . , N (16)

and the remaining points of the tail for j=2, . . . , N points are obtained using eqs. (15)-(16). With these assumptions and the predefined Bᵢ values, the initial parameter values are computed from the reference points

$$( using \frac{\partial y ( t )}{\partial t} {\vert}_{t = {t}_{max , j}} = 0 )$$

and the following equations at step 105

$$\begin{matrix}{C}_{i , init} = {B}_{i} \frac{τ}{{t}_{max , i}} , i = 2 , … , N & ( 17 ) \\ {A}_{i , init} = {{y}_{max , i} ( \frac{τ}{{t}_{max , i}} )}^{{B}_{i}} {e}^{{B}_{i}} , i = 2 , … , N & ( 18 )\end{matrix}$$

3. “Optimal” Input Function Computation

At step 106, from the estimated collection of input functions {c_{p,1}(t), . . . , c_{p,M}(t)} we select the best one that minimizes the Bayesian Information Criterion (BIC)

$$B I C ( {χ}_{j}^{2} , {n}_{j} ) = log {χ}_{j}^{2} + {n}_{j} \frac{1}{T} log T , j = 1 , … , M \qquad ( 19 )$$

with nⱼ the number of free parameters of the model and T the number of samples (data points) used to estimate the parameters.

Referring to FIG. 3, the apparatus and method of the present invention are applicable to all image analysis products 301 employing pharmacokinetic modeling for enhanced analysis based on dynamic acquisition procedures. The analysis apparatus 200 or just the analysis software 202 may be bundled as a 300 with an imaging product 301.

Referring to FIG. 2, the analysis apparatus 200 is sold as stand-alone Automatic Estimation Procedure Module 200. The module comprises an initial value definition component 203 that, in an alternative embodiment, provides for manual interaction during the definition of initial values by an Initial Value definition component 201. These initial values are input to an Input Function Collection Definition Component 204 which provides a collection of functions such as those of eqs. (7)-(12). A (free) Kinetic Parameter Estimation Component 205 used the collection of functions to estimate parameters of the collection, preferable using step 2 above and eqs. (13)-18). Finally, an “optimal” one of the input function is computer by an Optimal Input Function Computation Component 206, preferably using step 3 above and eq. (19). The input values, defined values and computed value are all retained in a database 207 along with the resulting “optimal” BIC, for at least further analysis and later comparison with other such analyses.

While the preferred embodiments of the present invention have been illustrated and described, it will be understood by those skilled in the art that the system and apparatus architectures and methods as described herein are illustrative and various changes and modifications may be made and equivalents may be substituted for elements thereof without departing from the true scope of the present invention. In addition, many modifications may be made to adapt the teachings of the present invention to a particular set-up without departing from its central scope. Therefore, it is intended that the present invention not be limited to the particular embodiments disclosed as the best mode contemplated for carrying out the present invention, but that the present invention include all embodiments falling with the scope of the appended claims.

1. A method for estimating an input function in pharmacokinetic modelling, comprising the steps of:
creating a collection C of a plurality of input functions c_{p,j}(t) (101), each of a given type and each having at least one parameter;
estimating a corresponding value for each at least one parameter (104);
determining an estimated collection by setting each at least one parameter to the corresponding estimated value; and
computing an optimal input function (106) from the estimated collection of input functions making use of a predetermined goodness-of-fit (GOF) criterion
c_{p,opt}(t)=F(C).

2. The method of claim 1, wherein the computing step computes a weighted sum
$${c}_{p , opt} = ( t ) = {\sum }_{j = 1}^{M} {w}_{j} {c}_{p , j} ( t )$$
wherein the weights wⱼ are determined by the GOF criterion are
$${w}_{j} = \{ \begin{matrix}1 & GOF ( {c}_{p , j} ) = {min}_{j} GOF ( {c}_{p , j} ) \\ 0 & otherwise\end{matrix} .$$

3. The method of claim 1, wherein the predetermined goodness-of-fit criterion is selected from the group consisting of Akaike's Information Criterion (AIC) and Bayesian Information Criterion (BIC) (106).

4. The method of claim 1, wherein a collection of size M created as C={c_{p,1}(t), c_{p,2}(t), . . . , c_{p,M}(t)} of M input functions and the given type is a sum of weighted exponentials, where M covers all desired combinations of predefined parameter values and number of terms N
$${c}_{p} ( t ) = {\sum }_{i = 1}^{N} {{A}_{i} ( \frac{t}{τ} )}^{{B}_{i}} {e}^{- {C}_{i} t / τ}$$
where N is the number of terms in the input function, t is time and the 3N+1 parameters are
τ=a pre-determined time normalization parameter
Aᵢ=activity weight
Bᵢ=predefined dimensionless exponent
Cᵢ=normalized dimensionless time constant.

5. The method of claim 4, wherein the collection C of polynomial weighted exponential input functions is
$${c}_{p , 1} ( t ) = {A}_{1} ( \frac{t}{τ} ) {e}^{- {C}_{1} t / τ}$$
$${c}_{p , 2} ( t ) = {A}_{1} {e}^{- {C}_{1} t / τ}$$
$${c}_{p , 3} ( t ) = {A}_{1} ( \frac{t}{τ} ) {e}^{- {C}_{1} t / τ} + {A}_{2} ( \frac{t}{τ} ) {e}^{- {C}_{2} t / τ}$$
$${c}_{p , 4} ( t ) = {{A}_{1} ( \frac{t}{τ} )}^{2} {e}^{- {C}_{1} t / τ} + {A}_{2} ( \frac{t}{τ} ) {e}^{- {C}_{2} t / τ}$$
$${c}_{p , 5} ( t ) = {{A}_{1} ( \frac{t}{τ} )}^{2} {e}^{- {C}_{1} t / τ} + {{A}_{2} ( \frac{t}{τ} )}^{2} {e}^{- {C}_{2} t / τ}$$
$${c}_{p , 6} ( t ) = …$$

6. The method of claim 4, wherein Bᵢ are predefined as integer values between 0 and 5.

7. The method of claim 6, further comprising the steps of:
selecting a region of interest (ROI) from a measurement data set having a plurality of values;
setting N_{ROI} equal to the number of voxels of the measurement data set in the ROI;
and wherein the estimating step further comprises the step of solving separately for all input functions of the collection C with a nonlinear optimization procedure
$${min}_{{A}_{i , j} , {B}_{i , j} , {C}_{i , j}} {χ}_{j}^{2} , {χ}_{j}^{2} = {\sum }_{t = 1}^{T} ρ ( t ) {( {c}_{p , j} ( t ) - y ( t ) )}^{2} , j = 1 , … , M$$
where, on the ROI averaged data
$$y ( t ) = \frac{1}{{N}_{ROI}} {\sum }_{( x , y , z ) ∈ ROI} d ( t , x , y , z )$$
the measurements represent the activity distribution in time and space in the form of a 4D data set d(t, x, y, z), t=1, . . . , T.

8. The method of claim 7, wherein the estimating step further comprises the step of first determining an initial value for the at least one parameter from the measurement data set.

9. The method of claim 8, wherein the step of first determining an initial value further comprises the steps of:
for each input function of the at least one input function
assuming the input function has a peak value in the ROI that is modelled by its first term as follows
t_{max,1}=arg max y(t)
y_{max,1}=y(t_{max,1})
and that all further terms of the input function describe the remaining parts or tail as follows
t_{max,1}=t_{max,j-1}+(T−t_{max,1})/N, j=2, . . . , N
y_{max,j}=y(t_{max,j}), j=2, . . . , N
extracting a set of reference points based on a peak value using the foregoing equations,
computing initial parameter values from the extracted set of reference points
$$( using \frac{\partial y ( t )}{\partial t} {\vert}_{t = {t}_{max , j}} = 0 )$$
and the equations
$${C}_{i , init} = {B}_{i} \frac{τ}{{t}_{max , i}} , i = 2 , … , N$$
$${A}_{i , init} = {{y}_{max , i} ( \frac{τ}{{t}_{max , i}} )}^{{B}_{i}} {e}^{{B}_{i}} , i = 2 , … , N .$$

10. The method of claim 9, wherein the nonlinear optimization procedure is selected from the group consisting of Levenberg-Marquardt, Simplex, Conjugate-Gradient, and Simulated Annealing.

11. The method of claim 10, wherein Bᵢ are predefined as integer values between and including 0 and 5.

12. The method of claim 10, where the predetermined goodness-of-fit criterion is selected from the group consisting of Akaike's Information Criterion (AIC) and Bayesian Information Criterion (BIC).

13. The method of claim 12, wherein Bi are predefined as integer values between and including 0 and 5.

14. The method of claim 12, wherein the BIC is
$$BIC ( {χ}_{j}^{2} , {n}_{j} ) = log {χ}_{j}^{2} + {n}_{j} \frac{1}{T} log T , j = 1 , … , M$$
where
nⱼ=number of free parameters
χⱼ²=fitting error
T=number of time samples

15. The method of claim 14, wherein Bᵢ are predefined as integer values between and including 0 and 5.

16. The method of claim 15, wherein the computing step computes a weighted sum
$${c}_{p , opt} ( t ) = {\sum }_{j = 1}^{M} {w}_{j} {c}_{p , j} ( t )$$
wherein the weights wⱼ are determined by the GOF criterion
$${w}_{j} = \{ \begin{matrix}1 & GOF ( {c}_{p , j} ) = {min}_{j} GOF ( {c}_{p , j} ) \\ 0 & otherwise\end{matrix}$$

17. An apparatus (202) for estimation of an input function in pharmacokinetic modelling, comprising:
an initial value definition component (203) that defines a set of dimensionless exponents Bᵢ;
a manual interaction component (201) connected to the input value definition component for a user to direct the definition of the set of dimensionless exponents Bᵢ;
an input function collection component that creates a collection of a plurality of input functions c_{p,j}(t), each of a given type employing the defined corresponding Bᵢ and each having at least one parameter;
a free kinetic parameter estimation component (205) that estimates the at least one parameter for each input function of the created collection and thereby determines an estimated collection C from the created collection; and
an optimal input function computation component that computes and “optimal” input function from the at least one estimated input function making use of a predetermined goodness-of-fit (GOF) criterion
c_{p,opt}(t)=F(C).

18. The apparatus (202) of claim 17, wherein a collection of size M created as C={c_{p,1}(t), c_{p,2}(t), . . . , c_{p,M}(t)} of M input functions and the given type is a sum of weighted exponentials, where M covers all desired combinations of predefined parameter values and number of terms N
$${c}_{p} ( t ) = {\sum }_{i = 1}^{N} {{A}_{i} ( \frac{t}{τ} )}^{{B}_{i}} {e}^{- {C}_{i} t / τ}$$
where N is the number of terms in the input function, t is time and the 3N+1 parameters are
τ=a pre-determined time normalization parameter
Aᵢ=activity weight
Bᵢ=predefined dimensionless exponent
Cᵢ=normalized dimensionless time constant.

19. The apparatus (202) of claim 18, wherein Bi are predefined as integer values between and including 0 and 5.

20. The apparatus (202) of claim 19, wherein the collection C of polynomial weighted exponential input functions is
$${c}_{p , 1} ( t ) = {A}_{1} ( \frac{t}{τ} ) {e}^{- {C}_{1} t / τ}$$
$${c}_{p , 2} ( t ) = {A}_{1} {e}^{- {C}_{1} t / τ}$$
$${c}_{p , 3} ( t ) = {A}_{1} ( \frac{t}{τ} ) {e}^{- {C}_{1} t / τ} + {A}_{2} ( \frac{t}{τ} ) {e}^{- {C}_{2} t / τ}$$
$${c}_{p , 4} ( t ) = {{A}_{1} ( \frac{t}{τ} )}^{2} {e}^{- {C}_{1} t / τ} + {A}_{2} ( \frac{t}{τ} ) {e}^{- {C}_{2} t / τ}$$
$${c}_{p , 5} ( t ) = {{A}_{1} ( \frac{t}{τ} )}^{2} {e}^{- {C}_{1} t / τ} + {{A}_{2} ( \frac{t}{τ} )}^{2} {e}^{- {C}_{2} t / τ}$$
$${c}_{p , 6} ( t ) = …$$

21. The apparatus (202) of claim 20, wherein
$${c}_{p , opt} ( t ) = {\sum }_{j = 1}^{M} {w}_{j} {c}_{p , j} ( t )$$
and the weights wⱼ are determined by the GOF criterion are
$${w}_{j} = \{ \begin{matrix}1 & GOF ( {c}_{p , j} ) = {min}_{j} GOF ( {c}_{p , j} ) \\ 0 & otherwise\end{matrix} .$$

22. The apparatus (202) of claim 21, wherein the predetermined goodness-of-fit criterion is selected from the group consisting of Akaike's Information Criterion (AIC) and Bayesian Information Criterion (BIC).

23. The apparatus (202) of claim 22, wherein the BIC is
$$BIC ( {χ}_{j}^{2} , {n}_{j} ) = log {χ}_{j}^{2} + {n}_{j} \frac{1}{T} log T , j = 1 , … , M$$
where
nⱼ=number of free parameters
χⱼ²=fitting error
T=number of time samples.

24. An apparatus (200) for estimation of an input function in pharmacokinetic modelling, comprising an automatic estimation procedure module configured to perform the method of claim 16.

25. A system (300) for pharmacokinetic modeling, comprising an image analysis product (301) employing pharmacokinetic modeling (200-207) for enhanced analysis based on dynamic acquisition procedures further configured to perform the method of claim 16 to estimate input functions (205) and provide the input functions to the pharmacokinetic modeling.

26. A system (300) for pharmacokinetic modeling, comprising:
an image analysis component (301) that uses a pharmacokinetic model;
an apparatus (202) configured according to claim 17 and connected to the image analysis component (301) for input function estimation for the pharmacokinetic model.
